(19) United States
(12) Patent Application Publication
(10) Pub. No.: US 2026/0238247 A1
(43) Pub. Date: Aug. 13, 2026

(54) APPARATUS, SYSTEM, AND METHOD FOR EXCHANGING DATA IN A ROTATING ELECTRICAL CONNECTOR

(71) Applicant: STMICROELECTRONICS (CHINA) INVESTMENT CO., LTD, Shanghai (CN)

(72) Inventor: Hao LI, Shanghai (CN)

(21) Appl. No.: 19/156,147

(22) PCT Filed: Feb. 14, 2023
(86) PCT No.: PCT/CN2023/075931

§ 371 Date: Aug. 13, 2025

(51) Int. Cl. H04B 1/40; H01R 39/64

(52) U.S. Cl. CPC H04B 1/40; H01R 39/64

(57) ABSTRACT

Example apparatuses, systems, and methods for exchanging data and power in a rotating electrical connector are provided. The example rotating electrical connector may include a connector housing, with a first connector portion and a second connector portion placed within the connector housing. The first connector portion may include a first wireless transceiver electrically connected to a first compute device. The second connector portion may include a second wireless transceiver electrically connected to a second compute device. In addition, the second connector portion may rotate in relation to the connector housing. Further, the first compute device and the second compute device may exchange electronic data through the first wireless transceiver and the second wireless transceiver. In some embodiments, the first compute device may further include a power source, and the power source may provide power to the second compute device through a mechanical slip ring connector.

### TECHNOLOGICAL FIELD

Embodiments of the present disclosure relate generally to rotating electrical connectors, and more particularly, to utilizing wireless transceivers to transfer data in a rotating electrical connector.

### BACKGROUND

Various example embodiments address technical problems associated with exchanging data in a rotating electrical connector, such as a slip ring connector. As understood by those of skill in the field to which the present disclosure pertains, there are numerous example scenarios in which a user may need to exchange data between compute devices across a rotating electrical connector.

For example, many electronic systems utilize a slip ring connector to exchange data between a stationary or fixed compute device and a compute device capable of rotation. One approach that has been used is to design a slip ring connector with two portions, a stator portion that remains fixed and a rotor portion that rotates. In some embodiments, the rotor portion may include one or more conductive discs, while the stator portion includes an equal number of conductive prongs. The conductive prongs are pressed against the conductive discs, creating an electrical connection by contact with the conductive disc. The conductive disc may continue to rotate while the conductive prong slides along the surface of the conductive disc.

Applicant has identified many technical challenges and difficulties associated with transferring power and data between computing devices in a rotating electrical connector. Through applied effort, ingenuity, and innovation, Applicant has solved problems related to transferring data in a rotating electrical connector by developing solutions embodied in the present disclosure, which are described in detail below.

### BRIEF SUMMARY

Various embodiments are directed to an example apparatus, system, and method for transferring data in a rotating electrical connector.

In accordance with some embodiments of the present disclosure, an example rotating electrical connector is provided. The rotating electrical connector may comprise a connector housing, a first connector portion disposed within the connector housing, and a second connector portion disposed within the connector housing. The first connector portion may comprise a first wireless transceiver, wherein the first connector portion is electrically connected to a first compute device. The second connector portion may comprise a second wireless transceiver, wherein the second connector portion is electrically connected to a second compute device. In addition, the second connector portion may rotate in relation to the connector housing. Further, the first compute device and the second compute device may exchange electronic data through the first wireless transceiver and the second wireless transceiver.

In some embodiments, the first connector portion may be fixed to the connector housing.

In some embodiments, the second connector portion may rotate at least 360 degrees in relation to the connector housing.

In some embodiments, second compute device may be associated with an imaging device.

In some embodiments, the second compute device may be associated with a remote sensing device utilizing electromagnetic waves to measure a location and/or speed of an object.

In some embodiments, the rotating electrical connector may further comprise a mechanical slip ring connector, wherein a first mechanical slip ring connector portion comprises a conductive ring, and a second mechanical slip ring connector portion comprises a conductive prong, wherein the conductive prong is configured to make electrical contact with the conductive ring.

In some embodiments, the first compute device further comprises a power source, wherein the power source may provide power to the second compute device through the mechanical slip ring connector.

In some embodiments, a first data portion of the electronic data may be transmitted through the mechanical slip ring connector and a second data portion of the electronic data may be transmitted through the first wireless transceiver and the second wireless transceiver, wherein the first data portion of the electronic data is transmitted at a slower data rate than the second data portion of electronic data.

In some embodiments, the first wireless transceiver and the second wireless transceiver may transmit the electronic data at a wavelength between 1 millimeter and 10 millimeters.

In some embodiments, a separation distance between the first wireless transceiver and the second wireless transceiver may be greater than 1 millimeter and less than 30 millimeters.

In some embodiments, the first wireless transceiver and the second wireless transceiver each comprise antennas configured to generate and receive a circular polarized electromagnetic wave.

In accordance with some embodiments of the present disclosure, an example system is also provided. The example system may comprise a rotating sensing device, a controller, and a rotating electrical connector. An example rotating electrical connector may comprise a connector housing, a first connector portion disposed within the connector housing, and a second connector portion disposed within the connector housing. The first connector portion may comprise a first wireless transceiver, wherein the first connector portion is electrically connected to a first compute device. The second connector portion may comprise a second wireless transceiver, wherein the second connector portion is electrically connected to a second compute device. In addition, the second connector portion may rotate in relation to the connector housing. Further, the first compute device and the second compute device may exchange electronic data through the first wireless transceiver and the second wireless transceiver.

In some embodiments, the rotating sensing device may be one of an imaging device, a radar transceiver, and a lidar transceiver.

In some embodiments, the system may further comprise a mechanical slip ring connector, wherein a first mechanical slip ring connector portion comprises a conductive ring, and a second mechanical slip ring connector portion comprises a conductive prong, wherein the conductive prong is configured to make electrical contact with the conductive ring.

In some embodiments, the controller may further comprise a power source, wherein the power source provides power to the rotating sensing device through the mechanical slip ring connector.

In some embodiments, a first data portion of the electronic data may be transmitted through the mechanical slip ring connector and a second data portion of the electronic data may be transmitted through the first wireless transceiver and the second wireless transceiver, wherein the first data portion of the electronic data is transmitted at a slower data rate than the second data portion of electronic data.

In some embodiments, the first wireless transceiver and the second wireless transceiver may transmit the electronic data at a wavelength between 1 millimeter and 10 millimeters.

In some embodiments, the first wireless transceiver and the second wireless transceiver may each comprise antennas configured to generate and receive a circular polarized electromagnetic wave.

An example method for transmitting data in a rotating electrical connector is further provided. In some embodiments, the rotating electrical connector may comprise a connector housing, a first connector portion disposed within the connector housing, the first connector portion electrically connected to a first compute device and comprising a first wireless transceiver, and a second connector portion disposed within the connector housing, the second connector portion electrically connected to a second compute device and comprising a second wireless transceiver. In addition, the second connector portion may rotate in relation to the connector housing. In some embodiments, the method may comprise transmitting first electronic data from the first wireless transceiver, receiving the first electronic data at the second wireless transceiver, transmitting second electronic data from the second wireless transceiver, and receiving the second electronic data at the first wireless transceiver.

In some embodiments, the rotating electrical connector may further comprise a mechanical slip ring connector, the mechanical slip ring connector comprising a first mechanical slip ring connector portion comprising a conductive ring, and a second mechanical slip ring connector portion comprising a conductive prong, wherein the conductive prong is configured to make electrical contact with the conductive ring, and wherein the first compute device further comprises a power source. The method may further comprise receiving electrical power from the power source and transmitting the electrical power to the second compute device through the electrical contact between the conductive prong and the conductive ring.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example prior art slip ring connector utilized in accordance with an example embodiment of the present disclosure.

FIG. 2 illustrates an example rotating electrical connector connecting two compute devices in accordance with an example embodiment of the present disclosure.

FIG. 3 illustrates a cross-section of an example rotating electrical connector in accordance with an example embodiment of the present disclosure.

FIG. 4 illustrates a cross-section of an example rotating electrical connector from another perspective in accordance with an example embodiment of the present disclosure.

FIG. 5 illustrates an example rotating electrical connector comprising both wireless transmissions and transmission through a slip ring connector in accordance with an example embodiment of the present disclosure.

FIG. 6 depicts a block diagram of an example system utilizing a rotating electrical connector in accordance with an example embodiment of the present disclosure.

FIG. 7 illustrates an example block diagram showing example components of a controller in accordance with an example embodiment of the present disclosure.

FIG. 8 depicts a flowchart illustrating an example method for exchanging data and power in a rotating electrical connector in accordance with an example embodiment of the present disclosure.

### DETAILED DESCRIPTION

Example embodiments will be described more fully hereinafter with reference to the accompanying drawings, in which some, but not all embodiments of the inventions of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

Various example embodiments address technical problems associated with exchanging data in a rotating electrical connector, such as a slip ring connector. As understood by those of skill in the field to which the present disclosure pertains, there are numerous example scenarios in which a user may need to exchange data between compute devices across a rotating electrical connector.

A rotating electrical connector enables the transfer of power and/or data between stationary and rotating electrical components. Numerous technologies exist which may benefit from the use of a rotating electrical connector. For example, industrial machinery, robotics, wind turbines, cameras, remote sensing devices (e.g., radar, lidar sensors), and/or other similar electromechanical devices. As a specific example, a security camera may comprise a stationary base mounted to a surface and an imaging device comprising a lens and optical sensor capable of rotation and/or yaw, pitch, and roll movement. One approach that has been used to provide electrical connectivity between a stationary compute device and a rotating compute device has been to maintain a physical or mechanical connection between the two compute devices. A physical or mechanical connection may be maintained by electrically connecting the rotating compute device to a rotating conductive disk or series of conductive discs (e.g., rotor). In addition, the stationary compute device may be electrically connected to a conductive prong or set of prongs that electrically contact the rotating conductive disks (e.g., stator). Such an approach allows the conductive disks to rotate while the conductive prongs remain in contact with the conductive disks. However, the conductive prongs sliding across the conductive disks may degrade over time. In addition, in some instances, the conductive prongs may lose contact with the conductive disks. Over time, the electrical connection may become weak and data transmission may become unreliable, especially for transmission of data at high frequencies.

Another approach that has been used is to enable transmission of data in a rotating electrical connector is to transmit data using optical signals. In such an embodiment, optical signals are transmitted in the rotating electrical connector by a stationary transceiver and received by a rotating optical transceiver, and vice versa. However, such rotating electrical connectors experience large losses resulting in signal attenuation, mainly caused by angular and axial misalignments.

The various example embodiments described herein utilize various techniques to transmit data in a rotating electrical connector. For example, in some embodiments, a fixed compute device may be electrically connected to a fixed wireless transceiver attached to the stator within the connector housing. In addition, a rotating compute device may be electrically connected to a rotating wireless transceiver attached to the rotor, also within the connector housing. The fixed wireless transceiver and the rotating wireless transceiver may be directed at each other, having a separation distance between the two wireless transceivers. Data transmitted from the fixed compute device to the rotating compute device may be transmitted from the fixed compute device to the fixed wireless transceiver. The data may then be transmitted by the fixed wireless transceiver and received by the rotating wireless transceiver electrically connected to the rotating compute device. Similarly, data transmitted from the rotating compute device to the fixed compute device may be transmitted by the rotating wireless transceiver and received by the fixed wireless transceiver, electrically connected to the fixed compute device. Enabling communication through the fixed wireless transceiver and the rotating wireless transceiver allows the rotating compute device to rotate continuously, without straining or wearing down mechanical electrical contacts.

In order to support higher data rates (e.g., data rates above 100 megabits per second), in some embodiments, the wireless transceiver may comprise components with an operating frequency between 30 GHz (10 millimeter wavelength) and 300 GHz (1 millimeter wavelength) capable of transmitting data at a rate between 100 megabits per second and 10 gigabits per second. Further, the wireless transceiver may include an antenna capable of transmitting waves with a circular polarization, enabling the transmission and reception of high speed data no matter the rotational relationship of the transmitting and receiving wireless transceiver.

In addition, in some embodiments, a rotating electrical connector may include a physically connected mechanical slip ring connection. The mechanical slip ring connection may be utilized to transmit power and data transmitted at lower frequencies. Using the mechanical slip ring connection to transmit power may provide a more efficient transfer of electrical power than transferring the electrical power wirelessly.

As a result of the herein described example embodiments and in some examples, the reliability of high speed data transfer in the rotating electrical connector may be greatly improved. In addition, in some embodiments, low data rate data and power may continue to be transmitted through a mechanical slip ring connection.

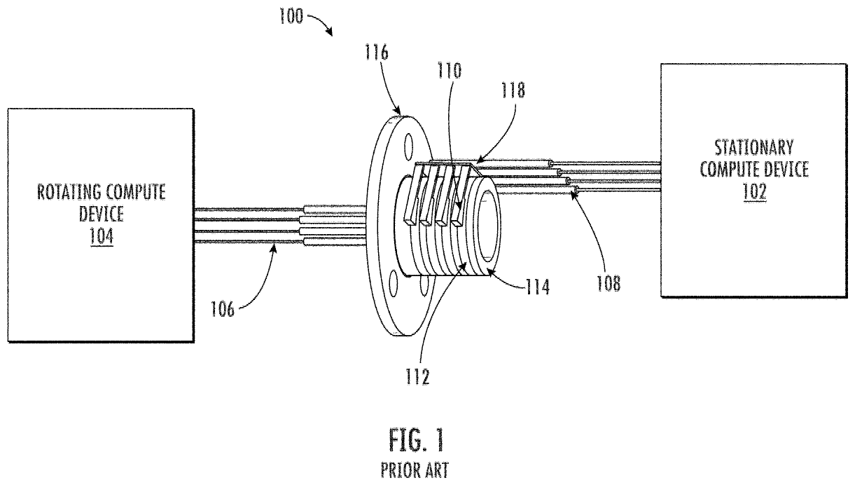

Referring now to FIG. 1, an example prior art slip ring connector 100 electrically connected to a fixed compute device 102 and a rotating compute device 104 is provided. As depicted in FIG. 1, the example slip ring connector 100 includes a rotating portion (e.g., rotor portion 114) permitted to rotate within a stationary portion (e.g., stator portion 116). The rotor portion 114 further comprises a plurality of conductive rings 112 attached to and encircling the exterior of the rotor portion 114. The conductive rings 112 configured to rotate as the rotor portion 114 rotates within the stator portion 116 of the slip ring connector 100. Each of the conductive rings 112 is electrically connected to a conductive wire of the rotating wired connection 106, wherein the rotating wired connection 106 provides an electrical connection between the conductive rings 112 and the rotating compute device 104. In an instance in which the rotating compute device 104 rotates, the rotating wired connection 106, rotor portion 114, and conductive rings 112 all rotate in unison. As further depicted by FIG. 1, the slip ring connector 100 further includes a brush block 118 attached to the stationary stator portion 116 and extending over at least a portion of the rotor portion 114. Attached to the brush block 118 are a plurality of conductive prongs 110 or brushes. Each conductive prong 110 extends from the brush block 118 and contacts one of the plurality of conductive rings 112. Each of the conductive prongs 110 is further electrically connected to a conductive wire of the fixed wired connection 108, wherein the fixed wired connection 108 provides an electrical connection between the conductive prongs 110 and the fixed compute device 102. In an instance in which the rotating compute device 104 and the rotor portion 114 rotate, the conductive prongs 110 slide across the surface of the conductive rings 112 maintaining an electrical connection between the fixed compute device 102 and the rotating compute device 104 via the fixed wired connection 108 and the rotating wired connection 106.

As described herein, the connection between the conductive rings 112 and the conductive prongs 110 may become warn or strained. In such an instance, the electrical connection may become unreliable, such that transmitted data between the fixed compute device 102 and the rotating compute device 104 may be partially or completely lost. The unreliable electrical connection may be particularly problematic for data transferred at higher frequencies and/or higher data rates.

As depicted in FIG. 1, the example slip ring connector 100 may provide a physical electrical connection between a fixed compute device 102 and a rotating compute device 104. A fixed compute device 102 may be any machine or device comprising hardware, software, firmware, and/or a combination thereof and configured to execute instructions and/or hard-coded functionality to perform operations defined by the particular device. Further, a fixed compute device 102 may be attached and/or stationary relative to the rotating compute device 104, such that the fixed compute device 102, the stator portion 116, the brush block 118 and the conductive prongs 110 remain stationary while the rotor portion 114 rotates within the stator portion 116. For example, the fixed compute device 102 may be a controller within the base portion of a security camera. Although primarily depicted as fixed, in some embodiments, a fixed compute device 102 may also rotate, move, and/or otherwise change positions relative to the slip ring connector 100.

As further depicted in FIG. 1, the slip ring connector 100 is electrically connected to a rotating compute device 104. A rotating compute device 104 may be any machine, circuit board, chip, or device comprising hardware, software, firmware, and/or a combination thereof and configured to receive electrical signals and execute instructions and/or hard-coded functionality to perform operations defined by the particular device. Further, a rotating compute device 104 may be configured to rotate relative to the fixed compute device 102. In some embodiments, the rotor portion 114 of the slip ring connector 100 may rotate in conjunction with the rotating compute device 104, such that the rotor portion 114 remains stationary in relation to the rotating compute device 104 but the rotor portion rotates within the stator portion 116 of the slip ring connector 100. An example rotating compute device 104 may be a camera device capable of movement mounted to a stationary base, for example a security camera. Further examples include rotating radar and/or lidar sensors, including radar and lidar transceivers, for example, mounted on a car or drone. Radar, lidar, and similar technologies may transmit electromagnetic waves and receive reflected electromagnetic waves to measure the location and/or speed of an object.

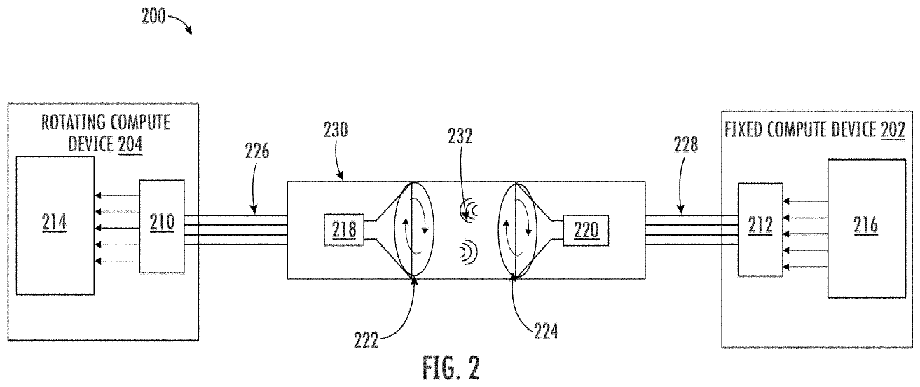

Referring now to FIG. 2, an example rotating electrical connector 200 is provided, electrically connecting a fixed compute device 202 and a rotating compute device 204. As depicted in FIG. 2, the rotating electrical connector 200 includes a connector housing 230 encasing a rotating antenna 222 electrically connected to a rotating wireless transceiver board 218 and further electrically connected to the rotating compute device 204 through the rotating data transmit lines 226. As depicted in FIG. 2, the rotating compute device 204 may include an interface chip 210 and a processor 214. As further depicted in FIG. 2, the connector housing 230 further encases a fixed antenna 224. As shown in FIG. 2, the rotating antenna 222 is directed at, and configured to transmit and receive wireless data 232 to/from the fixed antenna 224. The fixed antenna 224 is electrically connected to a fixed wireless transceiver board 220 and further electrically connected to a fixed compute device 202 via fixed data transmit lines 228.

As depicted in FIG. 2, the example rotating electrical connector 200 includes a connector housing 230. A connector housing 230 may be any enclosure, packaging, compartment, and/or similar structure configured to enclose the internal components of the rotating electrical connector 200. A connector housing 230 may comprise plastic, reinforced plastic, aluminum, steel, and/or any other material configured to protect, stabilize, and/or facilitate movement of the internal components of the rotating electrical connector 200. In some embodiments, the connector housing 230 may enclose the rotating wireless transceiver board 218, the rotating antenna 222, the fixed wireless transceiver board 220, and the fixed antenna 224, among other internal components. In some embodiments, the connector housing 230 may provide surfaces and/or attachment points to secure the fixed wireless transceiver board 220 and/or the fixed antenna 224 to the connector housing 230. In some embodiments, the connector housing 230 may include a rolling-element bearing, such as a ball bearing, to facilitate rotation of the rotating wireless transceiver board 218 and the rotating antenna 222 within the connector housing 230. In addition, the connector housing 230 may be configured to attach the internal elements of the rotating electrical connector 200 (e.g., rotating wireless transceiver board 218, rotating antenna 222, fixed wireless transceiver board 220, fixed antenna 224) such that the fixed antenna 224 and the rotating antenna 222 may send and receive data to and from each other. In such an instance, the antenna portion of the wireless transceivers (e.g., rotating antenna 222, fixed antenna 224) may be directed at each other. Further, the wireless transceivers may be fixed at a distance (e.g., separation distance) to facilitate reliable transmission of electronic data, without physical contact. For example, in some embodiments, the rotating antenna 222 and the fixed antenna 224 may be positioned such that the distance between the rotating antenna 222 and the fixed antenna 224 is between 0.1 millimeters and 100 millimeters; more preferably between 0.5 millimeters and 50 millimeters; most preferably between 1 millimeter and 30 millimeters.

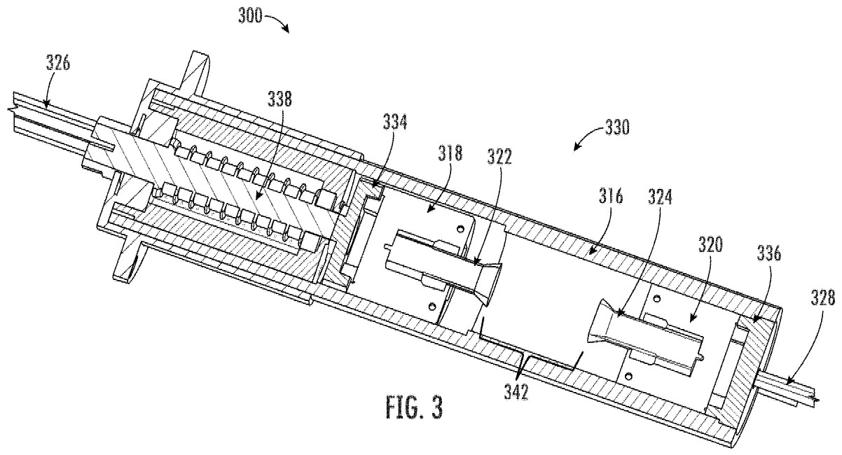

As further depicted in FIG. 2, the rotating electrical connector 200 includes a fixed wireless transceiver board 220 and a fixed antenna 224 positioned within the connector housing 230. In some embodiments, the fixed wireless transceiver board 220 and the fixed antenna 224 may be manufactured as a single component, herein referred to as a fixed wireless transceiver. The fixed wireless transceiver board 220 may comprise any insulating material, such as fiberglass or plastic, containing conductive pathways between the electrical components. For example the fixed wireless transceiver board 220 depicted in FIG. 2, may provide an electrical pathway between the fixed data transmit lines 228 and the fixed antenna 224. In addition, the fixed wireless transceiver board 220 may provide for the attachment and or placement of electrical components, for example the fixed antenna 224 on the surface of the fixed wireless transceiver board 220. In some embodiments, the fixed wireless transceiver board 220 may facilitate transmission and reception across an array of antennas. In some embodiments, the fixed wireless transceiver board 220 may be attached to the stator portion (e.g., stator portion 316 as further described in relation to FIG. 3) of the connector housing 230, such that the fixed wireless transceiver board 220 and the fixed antenna 224 remain in a static orientation in relation to the connector housing 230.

As further depicted in FIG. 2, the fixed wireless transceiver board 220 may be coupled with a fixed antenna 224. A fixed antenna 224 may be any component or device configured to transmit and receive wireless signals. A fixed antenna 224 may comprise one or more antennas and accompanying hardware, software, and/or firmware configured to facilitated the transmission and reception of electronic data, for example, electronic data exchanged between the fixed compute device 202 and the rotating compute device 204. In some embodiments, the hardware, software, and/or firmware supporting the transmission and reception of electronic data may be contained on the fixed wireless transceiver board 220.

The fixed wireless transceiver may implement a number of features and strategies to enable the transmission of electronic data (e.g., wireless data 232) at a high data rate. For example, in some embodiments, the fixed wireless transceiver may support full duplex electronic data transmission, enabling the transmission and reception of wireless data 232 simultaneously. In addition, the fixed wireless transceiver may support any variety of modulation schemes to encode wireless data 232, such as amplitude shift keying (ASK) modulation schemes, wherein the amplitude of the carrier wave may be varied to represent the electronic data. Additionally, wireless data 232 may be encoded in other modulation schemes, such as, frequency shift keying (FSK) modulation schemes, phase shift keying (PSK) modulation schemes. The fixed wireless transceiver may further support the encoding of wireless data 232 using non-return-to-zero (NRZ) methods, further enabling the transmission of wireless data 232 at higher data rates. In some embodiments, the fixed wireless transceiver may transmit wireless data 232 using a differential signaling method, such as serial low voltage signaling (SLVS), enabling wireless data 232 transmission and reception via two conductors. Further, in some embodiments, the fixed wireless transceiver may comprise a plurality of antennas formed in an array, enabling transmission of wireless data 232 using techniques such as beamforming.

Such techniques may enable the fixed wireless transceiver to support high frequencies and fast data rates. For example, in some embodiments, the fixed wireless transceiver may support transmission and reception of wireless data 232 in the millimeter band. The millimeter band may include the spectrum of wavelengths between 10 millimeters and 1 millimeter. As such, in some embodiments, the fixed wireless transceiver may send and receive wireless data 232 at a frequency between 30 gigahertz and 300 gigahertz; more preferably between 40 and 75 gigahertz; most preferably between 58 and 62 gigahertz. Transmitting wireless data 232 in the millimeter band may enable a fixed wireless transceiver to transmit and receive data at a data rate between 100 megabits per second and 10 gigabits per second.

Further, the fixed wireless transceiver may be configured to transmit and receive wireless data 232 utilizing electromagnetic waves having a circular polarization. Transmitting and receiving wireless data 232 using circular polarization may enable stable transfer of data between the fixed wireless transceiver and the rotating wireless transceiver even when the rotating wireless transceiver rotates about an axis in relation to the fixed wireless transceiver.

In some embodiments, the fixed wireless transceiver may comprise a transceiver similar to the ST60A2 manufactured by STMicroelectronics®).

As further depicted in FIG. 2, the rotating electrical connector 200 includes a rotating wireless transceiver board 218 and a rotating antenna 222 positioned within the connector housing 230 with the rotating antenna 222 directed toward the fixed antenna 224. In some embodiments, the rotating wireless transceiver board 218 and the rotating antenna 222 may be manufactured as a single component, herein referred to as a rotating wireless transceiver. The rotating wireless transceiver board 218 may comprise any insulating material, such as fiberglass or plastic, containing conductive pathways between the electrical components. For example the rotating wireless transceiver board 218 depicted in FIG. 2, may provide an electrical pathway between the rotating data transmit lines 226 and the rotating antenna 222. In addition, the rotating wireless transceiver board 218 may provide for the attachment and or placement of electrical components, for example the rotating antenna 222 on the surface of the rotating wireless transceiver board 218. In some embodiments, the rotating wireless transceiver board 218 may facilitate transmission and reception across an array of antennas.

As further depicted in FIG. 2, the rotating wireless transceiver board 218 may be coupled with a rotating antenna 222. A rotating antenna 222 may be any component or device configured to transmit and receive wireless signals. A rotating antenna 222 may comprise one or more antennas and accompanying hardware, software, and/or firmware configured to facilitated the transmission and reception of electronic data, for example, electronic data exchanged between the fixed compute device 202 and the rotating compute device 204. In some embodiments, the hardware, software, and/or firmware supporting the transmission and reception of electronic data may be contained on the rotating wireless transceiver board 218. In some embodiments, the rotating wireless transceiver board 218 may be attached to the rotor portion (e.g., rotor portion 338 as further described in relation to FIG. 3) of the connector housing 230, such that the rotating wireless transceiver board 218 and the rotating antenna 222 rotate inside of the connector housing 230. In such an embodiment, the rotating wireless transceiver board 218 and the rotating antenna 222 further rotate in relation to the fixed antenna 224.

The rotating wireless transceiver may implement a number of features and strategies to enable the transmission of electronic data (e.g., wireless data 232) at a high data rate. For example, in some embodiments, the rotating wireless transceiver may support full duplex electronic data transmission, enabling the transmission and reception of wireless data 232 simultaneously. In addition, the rotating wireless transceiver may support any variety of modulation schemes to encode wireless data 232, such as amplitude shift keying (ASK) modulation schemes, wherein the amplitude of the carrier wave may be varied to represent the electronic data. Additionally, wireless data 232 may be encoded in other modulation schemes, such as, frequency shift keying (FSK) modulation schemes, phase shift keying (PSK) modulation schemes. The rotating wireless transceiver may further support the encoding of wireless data 232 using non-return-to-zero (NRZ) methods, further enabling the transmission of wireless data 232 at higher data rates. In some embodiments, the rotating wireless transceiver may transmit wireless data 232 using a differential signaling method, such as serial low voltage signaling (SLVS), enabling wireless data 232 transmission and reception via two conductors. Further, in some embodiments, the rotating wireless transceiver may comprise a plurality of antennas formed in an array, enabling transmission of wireless data 232 using techniques such as beamforming.

Such techniques may enable the rotating wireless transceiver to support high frequencies and fast data rates. For example, in some embodiments, the rotating wireless transceiver may support transmission and reception of wireless data 232 in the millimeter band. The millimeter band may include the spectrum of wavelengths between 10 millimeters and 1 millimeter. As such, in some embodiments, the rotating wireless transceiver may send and receive wireless data 232 at a frequency between 30 gigahertz and 300 gigahertz; more preferably between 40 and 75 gigahertz; most preferably between 58 and 62 gigahertz. Transmitting electronic data in the millimeter band may enable a rotating wireless transceiver to transmit and receive data at a data rate between 100 megabits per second and 10 gigabits per second.

Further, the rotating wireless transceiver may be configured to transmit and receive wireless data 232 utilizing electromagnetic waves having a circular polarization. Transmitting and receiving wireless data 232 using circular polarization may enable stable transfer of data between the fixed wireless transceiver and the rotating wireless transceiver even when the rotating wireless transceiver rotates about an axis in relation to the fixed wireless transceiver.

In some embodiments, the rotating wireless transceiver may comprise a transceiver similar to the ST60A2 manufactured by STMicroelectronics®.

As further depicted in FIG. 2, the example rotating electrical connector 200 may be electrically connected to the fixed compute device 202 using fixed data transmit lines 228 and to the rotating compute device 204 using rotating data transmit lines 226. The data transmit lines (e.g., fixed data transmit lines 228, rotating data transmit lines 226) may be any wire, cord, channel, waveguide, or other line configured to transmit electronic data, for example, a conductive wire cable and/or a fiber optic cable. The data transmit lines communicatively connect the associated device with the rotating electrical connector 200. As further described herein, the fixed data transmit lines 228 may connect to the stationary portion of the rotating electrical connector 200 and to the fixed wireless transceiver board 220. The rotating data transmit lines 226 may connect to the rotating portion of the rotating electrical connector 200 and to the rotating wireless transceiver board 218.

As further depicted in FIG. 2, the fixed compute device 202 and the rotating compute device 204 may comprise an interface chip (e.g., interface chip 210, 212) and a processor (e.g., processor 214, 216). In some embodiments, the interface chip 210, 212 may convert data received from the rotating electrical connector 200 and the on-board wireless transceiver (e.g., rotating wireless transceiver, fixed wireless transceiver) into a protocol recognized by the processor 214, 216. Additionally, the interface chip 210, 212 may convert electronic data to be transmitted across the rotating electrical connector 200 to a protocol recognized by the on-board wireless transceiver. For example, in some embodiments, the on-board wireless transceiver may utilize an 8 bit/10 bit encoding to transmit data from one wireless transceiver to the other. An interface chip 210, 212 may convert electronic data to and from the 8 bit/10 bit encoding to facilitate transmission across the rotating electrical connector 200.

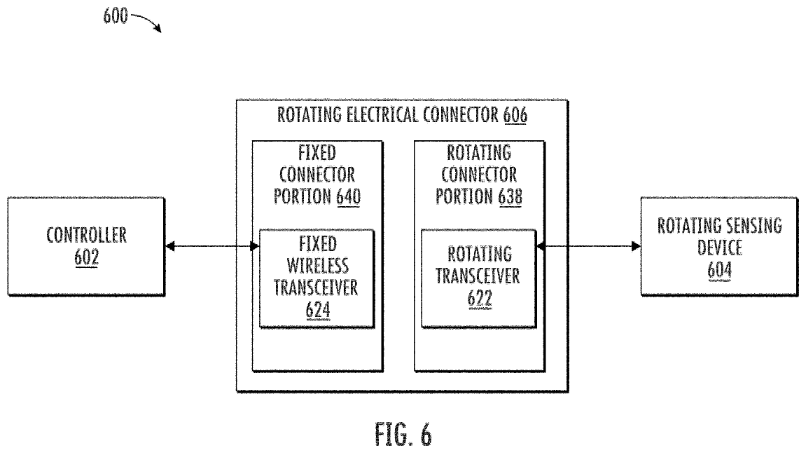

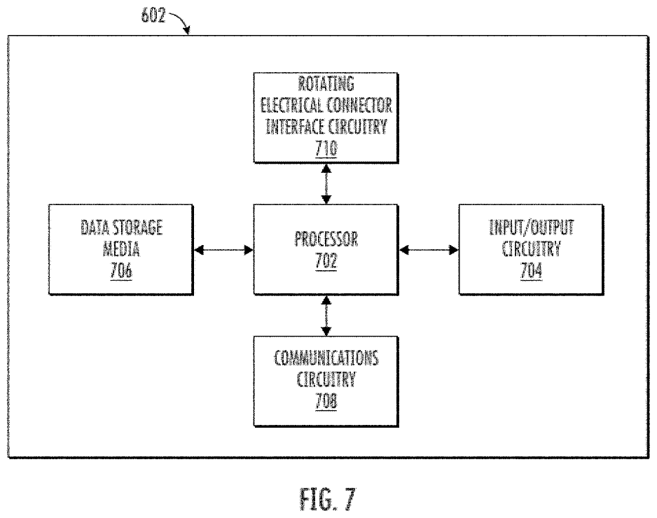

The fixed compute device 202 and the rotating compute device 204 may further include a processor 214, 216. A processor 214, 216 may be any configured to execute instructions stored in a data storage memory accessible to the processor. Alternatively or additionally, the processor 214, 216 in some embodiments may be configured to execute hard-coded functionality. As such, whether configured by hardware or software methods, or by a combination thereof, the processor 214, 216 represents an entity (e.g., physically embodied in circuitry) capable of performing operations in accordance with the operation of the particular device. A particular embodiment of an example processor, in conjunction with a controller (e.g., controller 602 as shown in reference to FIG. 6) is further described in relation to FIG. 7.

Referring now to FIG. 3, a cross-section of an example rotating electrical connector 300 is provided. As depicted in FIG. 3, the example rotating electrical connector 300 includes a rotor portion 338 (e.g., second connector portion) attached to a rotating transceiver base 334 configured to attach to a rotating wireless transceiver board 318 comprising a rotating antenna 322 (e.g., rotating wireless transceiver). As depicted in FIG. 3, the rotating wireless transceiver board 318 and associated rotating antenna 322 are configured to rotate within the connector housing 330. Further, the rotating data transmit lines 326 are electrically connected to the rotor portion 338 of the rotating electrical connector 300 and subsequently electrically connected to the rotating wireless transceiver, thus providing an electrical connection to the rotating compute device (e.g., rotating compute device 204 as described in relation to FIG. 1 and FIG. 2).

As further depicted in FIG. 3, the rotating antenna 322 is directed at a fixed antenna 324 separated by a separation distance 342, such that reliable transmission of electronic data may occur without the wear of a mechanical slip ring connection. As depicted in FIG. 3, the fixed antenna 324 and associated fixed wireless transceiver board 320 (e.g., fixed wireless transceiver) are attached to the fixed transceiver base 336. The fixed transceiver base 336 is subsequently attached to the stator portion 316 (e.g., first connector portion) of the connector housing 330. Thus, the fixed antenna 324 is stationary in relation to the connector housing 330 while the rotating antenna 322 rotates in relation to the connector housing 330 and the fixed antenna 324. As further depicted in FIG. 3, the fixed wireless transceiver is electrically connected to the fixed data transmit lines 328, providing an electrical connection to the fixed compute device (e.g., fixed compute device 202 as described in relation to FIG. 1 and FIG. 2).

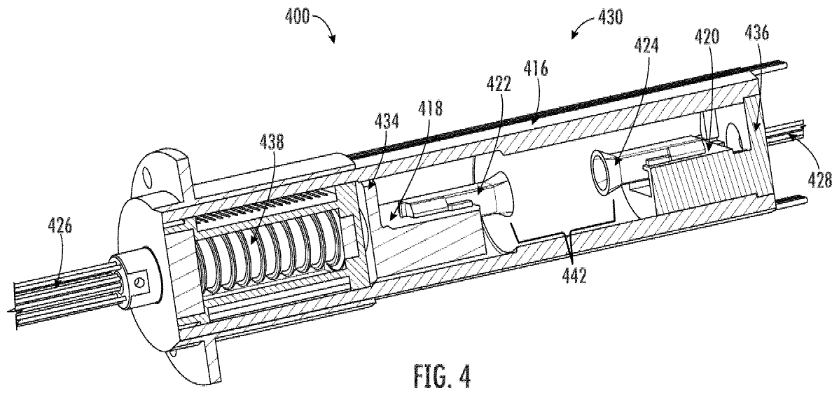

Referring now to FIG. 4, another perspective of an example rotating electrical connector 400 is provided. As depicted in FIG. 4, the example rotating electrical connector 400 includes a rotating antenna 422 and rotating wireless transceiver board 418 (e.g., rotating wireless transceiver) attached to a rotating transceiver base 434 of a rotor portion 438 (e.g., second connector portion) of a rotating electrical connector 400. Additionally, the rotating antenna 422 is electrically connected to a rotating compute device (e.g., rotating compute device 104, 204, via a plurality of rotating data transmit lines 426.

As further depicted in FIG. 4, the rotating antenna 422 is directed at a fixed antenna 424 and separated by a separation distance 442. As depicted in FIG. 4, the fixed antenna 424 and associated fixed wireless transceiver board 420 (e.g., fixed wireless transceiver) are attached to the fixed transceiver base 436. The fixed transceiver base 436 is subsequently attached to the stator portion 416 (e.g., first connector portion) of the connector housing 430. Thus, the fixed antenna 424 is stationary in relation to the connector housing 430 while the rotating antenna 422 rotates in relation to the connector housing 430 and the fixed antenna 424. As further depicted in FIG. 4, the fixed wireless transceiver is electrically connected to the fixed data transmit lines 428, providing an electrical connection to the fixed compute device (e.g., fixed compute device 102, 202).

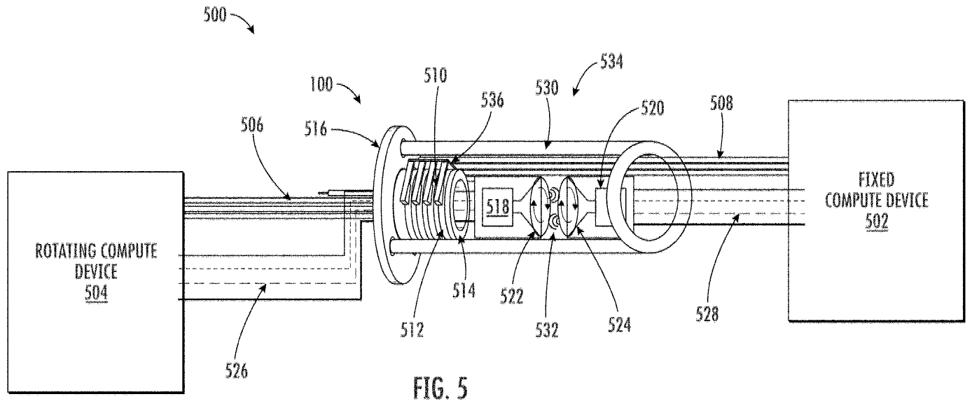

Referring now to FIG. 5, an example rotating electrical connector 500 comprising a slip ring connector 100 and a contactless rotating electrical connector 534 (e.g., rotating electrical connector 200, 300, 400) is provided. As depicted in FIG. 5, the rotating electrical connector 500 electrically connects a fixed compute device 502 to a rotating compute device 504 via the internal components of the rotating electrical connector 500. A physical electrical connection (e.g., mechanical slip ring connection) between the fixed compute device 502 and the rotating compute device 504 is provided by the slip ring connector 100. As depicted in FIG. 5, the fixed compute device 502 is electrically connected to a brush block 536 attached to the stator portion 516 of the slip ring connector 100, via the fixed wired connection 508. As described herein, the brush block 536 comprises a plurality of conductive prongs 510, each corresponding to a wire or line of the fixed wired connection 508. The example rotating compute device 504 is connected to the rotor portion 514 of the slip ring connector 100 comprising a plurality of conductive rings 512. As described herein, each conductive ring corresponds to a wire or line of the rotating wired connection. The conductive prongs 510 are pressed against the conductive rings 512, creating a physical electrical connection or mechanical slip ring connection between the fixed compute device 502 and the rotating compute device 504.

The mechanical slip ring connection created by the slip ring connector 100 may be particularly useful for the transmission of power and for the transmission of electronic data at lower data rates, for example, data transmitted below 100 megabits per second. The mechanical slip ring connection may provide reliable and efficient transmission of power compared to a wireless transmission of power. In addition, data transmitted at lower data rates is less likely to be corrupt or fail transmission as the mechanical slip ring connection begins to wear down. Electronic data suitable for transmission at lower data rates may include control and command data, for example, data messages requesting updates to a camera position or configuring the output of a camera.

As further depicted in FIG. 5, a high speed contactless data connection between the fixed compute device 502 and the rotating compute device 504 is provided by the rotating electrical connector 500. As depicted in FIG. 5, the fixed compute device 502 further includes a set of fixed data transmit lines 528. The fixed data transmit lines 528 are electrically connected to the fixed wireless transceiver board 520 and the fixed antenna 524 (herein referred to as the fixed wireless transceiver) of the contactless rotating electrical connector 534. The fixed compute device 502 may transmit and receive electronic data through the fixed data transmit lines 528. The fixed antenna 524 and fixed wireless transceiver board 520 may be attached to the stator portion 516 of the connector housing 530 such that the fixed wireless transceiver remains stationary in relation to the connector housing 530. The fixed wireless transceiver may be configured to transmit and receive wireless data 532 to and from the rotating wireless transceiver.

Additionally, as depicted in FIG. 5, the rotating compute device 504 may be electrically connected to the rotating antenna 522 and the rotating wireless transceiver board 518 (herein referred to as the rotating wireless transceiver) via the rotating data transmit lines 526. In some embodiments, the rotating wireless transceiver may be attached, or otherwise connected to the rotor portion 514 of the slip ring connector 100, such that the rotating wireless transceiver may rotate within the connector housing 530. In some embodiments, the contactless rotating electrical connector 534 may comprise a separate shaft, enabling the rotating wireless transceiver to rotate in relation to the connector housing 530.

The high speed contactless data connection created by the contactless rotating electrical connector 534 may be particularly useful for the transmission of data requiring high data rates, for example electronic data transmitted at a frequency above 30 gigahertz and requiring data rates above 100 megabits per second. The high speed contactless connection may provide a reliable data connection, even after the mechanical slip ring connection has begun to wear or strain. Electronic data requiring transmission at higher data rates may include high capacity data, for example, video streams from security cameras.

Referring now to FIG. 6, an example block diagram of a system 600 utilizing a rotating electrical connector 606 is provided. As depicted in FIG. 6, the system comprises a controller 602 electrically connected to a rotating sensing device 604 through a rotating electrical connector 606. The rotating electrical connector includes a fixed connector portion 640 (e.g., first connector portion) comprising a fixed wireless transceiver 624. The rotating electrical connector 606 further includes a rotating connector portion 638 (e.g., second connector portion) comprising a rotating transceiver 622.

As depicted in FIG. 6, the example system 600 includes a controller 602. A controller 602 may include any processing device, machine, microcontroller, or other electronic device configured to send and receive electronic data to the rotating sensing device 604. In some embodiments, the controller 602 may initiate commands to control and configure the operation of the rotating sensing device 604, for example controlling the position of the rotating sensing device 604. In some embodiments, the controller 602 may further include a power source to provide power to the rotating sensing device. In such an embodiment, the rotating electrical connector 606 may further include a slip ring connector (e.g., slip ring connector 100) to transmit power through the rotating electrical connector 606 to the rotating sensing device 604. An example controller 602 is further described in relation to FIG. 7.

As further depicted in FIG. 6, the example system 600 includes a rotating sensing device 604. A rotating sensing device 604 may be any sensor or device comprising hardware, software, firmware, and/or a combination thereof and configured to collect data related to the physical environment around the rotating sensing device 604. Further, a rotating sensing device 604 may be configured to rotate relative to the controller 602. Non-limiting examples of rotating sensing devices 604 may include radar and/or lidar sensors and associated circuitry, cameras and/or other imaging devices, etc. A rotating sensing device 604 may be configured to receive command and configuration electronic data from a controller 602. For example, a rotating sensing device 604 may receive configuration parameters related to exposure time, ISO sensitivity, white balance, shutter speed, gain, frame rate, dynamic range, bit depth, update rate, frame rate, and other parameters related to the received electronic data. Further, the rotating sensing device 604 may receive configuration data related to the position of the rotating sensing device 604, for example, the controller 602 may direct the rotating sensing device 604 to a particular yaw, pitch, and roll based on the electronic data received from the rotating sensing device 604. A rotating sensing device 604 may further be configured to provide electronic data to the controller 602. For example, a rotating sensing device 604 may transmit imagery data, and/or other sensing data to the controller 602. Such data may have a need to be transmitted at a high frequency (e.g., greater than 30 gigahertz) and/or a high data rate (e.g., greater than 100 megabits per second). A rotating electrical connector 606 may utilize the rotating transceiver 622 and fixed wireless transceiver 624 to reliably transmit such high speed data.

Referring now to FIG. 7, FIG. 7 illustrates an example controller 602 in accordance with at least some example embodiments of the present disclosure. The example controller 602 includes processor 702, input/output circuitry 704, data storage media 706, communications circuitry 708, and rotating electrical connector interface circuitry 710. In some embodiments, the controller 602 is configured, using one or more of the sets of circuitry 702, 704, 706, 708, and/or 710, to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, two sets of circuitry may both leverage use of the same processor(s), network interface(s), storage medium(s), and/or the like, to perform their associated functions, such that duplicate hardware is not required for each set of circuitry. The user of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the controller 602 provide or supplement the functionality of other particular sets of circuitry. For example, the processor 702 in some embodiments provides processing functionality to any of the sets of circuitry, the data storage media 706 provides storage functionality to any of the sets of circuitry, the communications circuitry 708 provides network interface functionality to any of the sets of circuitry, and/or the like.

In some embodiments, the processor 702 (and/or co-processor or any other processing circuitry assisting or otherwise associated with the processor) is/are in communication with the data storage media 706 via a bus for passing information among components of the controller 602. In some embodiments, for example, the data storage media 706 is non-transitory and may include, for example, one or more volatile and/or non-volatile memories. In other words, for example, the data storage media 706 in some embodiments includes or embodies an electronic storage device (e.g., a computer readable storage medium). In some embodiments, the data storage media 706 is configured to store information, data, content, applications, instructions, or the like, for enabling the controller 602 to carry out various functions in accordance with example embodiments of the present disclosure.

The processor 702 may be embodied in a number of different ways. For example, in some example embodiments, the processor 702 includes one or more processing devices configured to perform independently. Additionally or alternatively, in some embodiments, the processor 702 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the controller 602, and/or one or more remote or “cloud” processor(s) external to the controller 602.

In an example embodiment, the processor 702 is configured to execute instructions stored in the data storage media 706 or otherwise accessible to the processor. Alternatively or additionally, the processor 702 in some embodiments is configured to execute hard-coded functionality. As such, whether configured by hardware or software methods, or by a combination thereof, the processor 702 represents an entity (e.g., physically embodied in circuitry) capable of performing operations according to an embodiment of the present disclosure while configured accordingly. Alternatively or additionally, as another example in some example embodiments, when the processor 702 is embodied as an executor of software instructions, the instructions specifically configure the processor 702 to perform the algorithms embodied in the specific operations described herein when such instructions are executed.

As one particular example embodiment, the processor 702 is configured to perform various operations associated with initializing and interacting with a rotating sensing device (e.g., rotating sensing device 604). In some embodiments, the processor 702 includes hardware, software, firmware, and/or a combination thereof, that transmits low data rate messages to the rotating sensing device via a rotating electrical connector (e.g., rotating electrical connector 606, rotating electrical connector 500). Additionally or alternatively, in some embodiments, the processor 702 includes hardware, software, firmware, and/or a combination thereof, that transmits power to the rotating sensing device via the rotating electrical connector. In some embodiments, the processor 702 includes hardware, software, firmware, and/or a combination thereof, that transmits power and/or low data rate messages to the rotating sensing device via a mechanical slip ring connection within the rotating electrical connector. Additionally or alternatively, in some embodiments, the processor 702 includes hardware, software, firmware, and/or a combination thereof, that transmits high data rate messages to the rotating sensing device via the rotating electrical connector. In some embodiments, the processor 702 includes hardware, software, firmware, and/or a combination thereof, that transmit high data rate messages to the rotating sensing device via the high speed contactless data connection within the rotating electrical connector. Additionally or alternatively, in some embodiments, the processor 702 includes hardware, software, firmware, and/or a combination thereof, that receives low data rate messages, for example, through a mechanical slip ring connection within the rotating electrical connector. Additionally or alternatively, in some embodiments, the processor 702 includes hardware, software, firmware, and/or a combination thereof, that receives high data rate messages, through a high speed contactless connection within the rotating electrical connector.

In some embodiments, the controller 602 includes input/output circuitry 704 that provides output to the user and, in some embodiments, to receive an indication of a user input. In some embodiments, the input/output circuitry 704 is in communication with the processor 702 to provide such functionality. The input/output circuitry 704 may comprise one or more user interface(s) (e.g., user interface) and in some embodiments includes a display that comprises the interface(s) rendered as a web user interface, an application user interface, a user device, a backend system, or the like. The processor 702 and/or input/output circuitry 704 comprising the processor may be configured to control one or more functions of one or more user interface elements through computer program instructions (e.g., software and/or firmware) stored on a memory accessible to the processor (e.g., data storage media 706, and/or the like). In some embodiments, the input/output circuitry 704 includes or utilizes a user-facing application to provide input/output functionality to a client device and/or other display associated with a user.

In some embodiments, the controller 602 includes communications circuitry 708. The communications circuitry 708 includes any means such as a device or circuitry embodied in either hardware or a combination of hardware and software that is configured to receive and/or transmit data from/to a network and/or any other device, circuitry, or module in communication with the controller 602. In this regard, the communications circuitry 708 includes, for example in some embodiments, a network interface for enabling communications with a wired or wireless communications network. Additionally or alternatively in some embodiments, the communications circuitry 708 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 708 includes circuitry for interacting with the antenna(s) and/or other hardware or software to cause transmission of signals via the antenna(s) or to handle receipt of signals received via the antenna(s). In some embodiments, the communications circuitry 708 enables transmission to and/or receipt of data from a client device in communication with the controller 602.

The rotating electrical connector interface circuitry 710 includes hardware, software, firmware, and/or a combination thereof, that supports various functionality associated with transmitting and receiving electronic data on a rotating electrical connector (e.g., rotating electrical connector 606, rotating electrical connector 500). For example, in some embodiments, the rotating electrical connector interface circuitry 710 may determine the transmit path for an electronic data transmission based on the type of data, the payload size of the data, the data priority, and/or other similar factors. In an instance in which the electronic data may be transmitted at a high data rate and/or at a high frequency, the rotating electrical connector interface circuitry 710 may transmit the data on the high speed contactless data connection by transmitting the data on a data transmit line (e.g., fixed data transmit lines 528). In an instance in which the data may be transmitted at a low data rate, the rotating electrical connector interface circuitry 710 may transmit the data on the mechanical slip ring connection within the rotating electrical connector. In some embodiments, the rotating electrical connector interface circuitry 710 may convert the electronic data for transmission to a protocol supported by the rotating electrical connector. For example, the rotating electrical connector interface circuitry 710 may convert the electronic data for transmission to 8-bit/10-bit protocol previous to transmitting the electronic data to the rotating electrical connector.

Additionally or alternatively, in some embodiments, one or more of the sets of circuitry 702-710 are combinable. Additionally or alternatively, in some embodiments, one or more of the sets of circuitry perform some or all of the functionality described associated with another component. For example, in some embodiments, one or more sets of circuitry 702-710 are combined into a single module embodied in hardware, software, firmware, and/or a combination thereof. Similarly, in some embodiments, one or more of the sets of circuitry, for example rotating electrical connector interface circuitry 710, is/are combined such that the processor 702 performs one or more of the operations described above with respect to each of these circuitry individually.

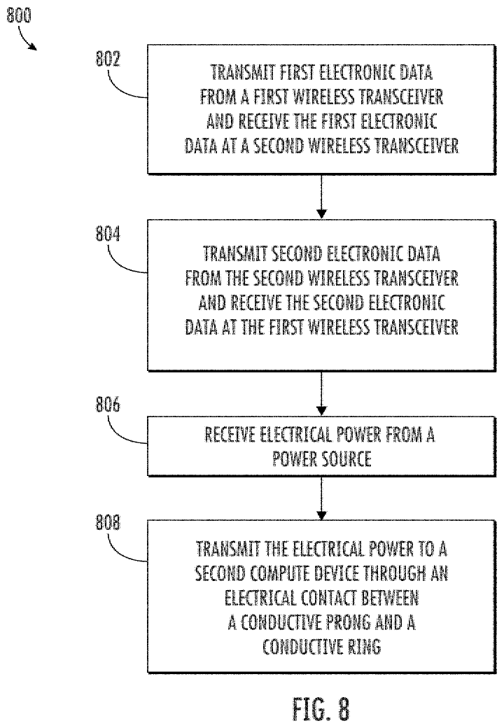

Referring now to FIG. 8, a flowchart illustrating an example method 800 for transmitting electronic data in a rotating electrical connector (e.g., rotating electrical connector 500) is provided. At block 802, the rotating electrical connector may transmit first electronic data from a first wireless transceiver (e.g., fixed wireless transceiver as described in FIG. 2-FIG. 6) and receive the first electronic data at a second wireless transceiver (e.g., rotating wireless transceiver as described in FIG. 2-FIG. 6). As described herein, the rotating electrical connector may comprise a high speed contactless connection between two compute devices (e.g., fixed compute device 502, rotating compute device 504). The high speed contactless connection may utilize a first and a second wireless transceiver separated by a distance. The separation of the wireless transceivers allows the rotating electrical connector to rotate, and the wireless transceivers to rotate with respect to each other, without any wear or strain on the communicating components. The proximity of the wireless transceivers enables transmission of the electronic data (e.g., first electronic data, second electronic data) to occur at a high frequency and/or high data rate. For example, between 58 and 62 gigahertz and at a data rate between 100 megabits per second and 10 gigabits per second. The high speed contactless connection may be preferable for transmitting data from a first compute device to a second compute device that may need to be transmitted at a high frequency (e.g., greater than 30 gigahertz) and/or a high data rate (greater than 100 megabits per second). Data to be transmitted on the high speed contactless connection of the rotating electrical connector may include high priority command and control data, and/or data comprising a large payload. Electronic data transmitted from the first compute device to the second compute device may be transmitted by the first wireless transceiver and received by the second wireless transceiver.

At block 804, the rotating electrical connector may transmit second electronic data from the second wireless transceiver and receive the second electronic data at the first wireless transceiver. The high speed contactless connection may additionally be utilized to transmit electronic data from the second compute device to the first compute device. Data to be transmitted on the high speed contactless connection of the rotating electrical connector may include high priority status data, high priority sensor data, imagery data, streaming video, and/or other sensor data. Electronic data transmitted from the second compute device to the first compute device may be transmitted by the second wireless transceiver and received by the first wireless transceiver.

At block 806, the rotating electrical connector may receive electrical power from a power source. In some embodiments, a first compute device (e.g., fixed compute device 102, 202, 502, controller 602) may comprise a power source. In some embodiments, the power source of the first compute device may be utilized to provide power to the second compute device (e.g., rotating compute device 104, 204, 504, rotating sensing device 604). In such an embodiment, electrical power may be transmitted from the power source of the first compute device to the rotating electrical connector for transmission to the second compute device.

At block 808, the rotating electrical connector may transmit the electrical power to a second compute device (e.g., rotating compute device 104, 204, 504, rotating sensing device 604) through an electrical contact between a conductive prong (e.g., conductive prong 110, 510) and a conductive ring (conductive ring 112, 512). A mechanical slip ring connection, as described herein, may provide a physical electrical contact between the conductive prong and the conductive ring. In some embodiments, a mechanical slip ring connection may be more reliable and efficient for transmitted electrical power than a wireless transmission. In addition, power transfer through the mechanical slip ring connection may not be severely affected by the wear on the physical electrical contacts of the slip ring connection. As such, a rotating electrical connector may transmit power through the mechanical slip ring connection, while transferring high frequency and/or high data rate electronic data through the high speed contactless connection. In some embodiments, the rotating electrical connector may further utilize the mechanical slip ring connection to transmit electronic data transmitted at lower frequency (e.g., below 30 gigahertz) and lower data rates (e.g., below 100 megabits per second).

While this detailed description has set forth some embodiments of the present invention, the appended claims cover other embodiments of the present invention which differ from the described embodiments according to various modifications and improvements. For example, one skilled in the art may recognize that such principles may be applied to any compute device or sensor capable of rotation. For example, security cameras, cameras mounted on aerial vehicles, including unmanned aerial vehicles, and other camera applications; moveable radar sensors, lidar sensors, and other sensing devices, particularly those mounted on vehicles, unmanned aerial vehicles, and other machines requiring proximity sensing; as well as numerous other applications involving a rotating compute device or sensor.

Within the appended claims, unless the specific term “means for” or “step for” is used within a given claim, it is not intended that the claim be interpreted under 35 U.S.C. 112, paragraph 6.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. A rotating electrical connector comprising:
a connector housing;
a first connector portion disposed within the connector housing, the first connector portion comprising:
a first wireless transceiver,
wherein the first connector portion is electrically connected to a first compute device; and
a second connector portion disposed within the connector housing, the second connector portion comprising:
a second wireless transceiver,
wherein the second connector portion is electrically connected to a second compute device;
wherein the second connector portion rotates in relation to the connector housing, and
wherein the first compute device and the second compute device exchange electronic data through the first wireless transceiver and the second wireless transceiver.

2. The rotating electrical connector of claim 1, wherein the first connector portion is fixed to the connector housing.

3. The rotating electrical connector of claim 1, wherein the second connector portion rotates at least 360 degrees in relation to the connector housing.

4. The rotating electrical connector of claim 1, wherein the second compute device is associated with an imaging device.

5. The rotating electrical connector of claim 1, wherein the second compute device is associated with a remote sensing device utilizing electromagnetic waves to measure a location and/or speed of an object.

6. The rotating electrical connector of claim 1, further comprising a mechanical slip ring connector, wherein a first mechanical slip ring connector portion comprises a conductive ring, and a second mechanical slip ring connector portion comprises a conductive prong, wherein the conductive prong is configured to make electrical contact with the conductive ring.

7. The rotating electrical connector of claim 6, wherein the first compute device further comprises a power source, and wherein the power source provides power to the second compute device through the mechanical slip ring connector.

8. The rotating electrical connector of claim 6, wherein a first data portion of the electronic data is transmitted through the mechanical slip ring connector and a second data portion of the electronic data is transmitted through the first wireless transceiver and the second wireless transceiver, and, wherein, the first data portion of the electronic data is transmitted at a slower data rate than the second data portion of electronic data.

9. The rotating electrical connector of claim 1, wherein the first wireless transceiver and the second wireless transceiver transmit the electronic data at a wavelength between 1 millimeter and 10 millimeters.

10. The rotating electrical connector of claim 1, wherein a separation distance between the first wireless transceiver and the second wireless transceiver is greater than 1 millimeter and less than 30 millimeters.

11. The rotating electrical connector of claim 1, wherein the first wireless transceiver and the second wireless transceiver each comprise antennas configured to generate and receive a circular polarized electromagnetic wave.

12. A system comprising:
a rotating sensing device;
a controller; and
a rotating electrical connector, the rotating electrical connector comprising:
a connector housing;
a first connector portion disposed within the connector housing, the first connector portion comprising:
a first wireless transceiver,
wherein the first connector portion is electrically connected to the controller; and
a second connector portion disposed within the connector housing, the second connector portion comprising:
a second wireless transceiver,
wherein the second connector portion is electrically connected to the rotating sensing device;
wherein the second connector portion rotates in relation to the connector housing, and
wherein the controller and the rotating sensing device exchange electronic data through the first wireless transceiver and the second wireless transceiver.

13. The system of claim 12, wherein the rotating sensing device is one of an imaging device, a radar transceiver, and a lidar transceiver.

14. The system of claim 12, further comprising a mechanical slip ring connector, wherein a first mechanical slip ring connector portion comprises a conductive ring, and a second mechanical slip ring connector portion comprises a conductive prong, wherein the conductive prong is configured to make electrical contact with the conductive ring.

15. The system of claim 14, wherein the controller further comprises a power source, and wherein the power source provides power to the rotating sensing device through the mechanical slip ring connector.

16. The system of claim 14, wherein a first data portion of the electronic data is transmitted through the mechanical slip ring connector and a second data portion of the electronic data is transmitted through the first wireless transceiver and the second wireless transceiver, and, wherein, the first data portion of the electronic data is transmitted at a slower data rate than the second data portion of electronic data.

17. The system of claim 12, wherein the first wireless transceiver and the second wireless transceiver transmit the electronic data at a wavelength between 1 millimeter and 10 millimeters.

18. The system of claim 12, wherein the first wireless transceiver and the second wireless transceiver each comprise antennas configured to generate and receive a circular polarized electromagnetic wave.

19. A method for transmitting data in a rotating electrical connector, the rotating electrical connector comprising a connector housing, a first connector portion disposed within the connector housing, the first connector portion electrically connected to a first compute device and comprising a first wireless transceiver, and a second connector portion disposed within the connector housing, the second connector portion electrically connected to a second compute device and comprising a second wireless transceiver, wherein the second connector portion rotates in relation to the connector housing, the method comprising:
transmitting first electronic data from the first wireless transceiver;
receiving the first electronic data at the second wireless transceiver;
transmitting second electronic data from the second wireless transceiver; and
receiving the second electronic data at the first wireless transceiver.

20. The method of claim 19, wherein the rotating electrical connector further comprises a mechanical slip ring connector, the mechanical slip ring connector comprising a first mechanical slip ring connector portion comprising a conductive ring, and a second mechanical slip ring connector portion comprising a conductive prong, wherein the conductive prong is configured to make electrical contact with the conductive ring, and wherein the first compute device further comprises a power source, the method comprising:
receiving electrical power from the power source; and
transmitting the electrical power to the second compute device through the electrical contact between the conductive prong and the conductive ring.
